(19) United States
(12) Patent Application Publication
(10) Pub. No.: US 2006/0209555 A1
(43) Pub. Date: Sep. 21, 2006

(54) High beam and low beam switch mechanism for head lights

(76) Inventors: Ming-Shan Kuo, Tainan (TW); Wei-Jen Chen, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/079,230

(22) Filed: Mar. 15, 2005

(51) Int. Cl. F21V 17/02

(52) U.S. Cl. 362/513; 362/280

(57) ABSTRACT

A head light assembly includes a reflector with a parabolic inner surface 11 so as to define an open end and a light bulb is located in the reflector. A cover board is engaged with a lower periphery of the open end and has a recess defined in a top edge thereof. A fixing plate is connected to an end of the cover board. An electromagnetic valve is connected to a connection board which is fixed to the fixing plate, and a push rod retractably extends from the electromagnetic valve. A cover plate has a connection portion at an end thereof and the push rod is connected to the connection portion so that the cover plate is driven to a first position to block the recess of the cover board and a second position to be located away from the recess of the cover board by the movement of the push rod. A lens is engaged with the open end of the reflector.

### FIELD OF THE INVENTION

The present invention relates to a switch mechanism for changing high beam and low beam of head lights of Ploy-Ellipsoid System (PES).

### BACKGROUND OF THE INVENTION

A conventional head light assembly of vehicles generally includes a reflector with a parabolic inner surface and two light bulbs are located at pre-set positions so that the light form the two light bulbs are reflected according to the curvature of the parabolic inner surface to become high and low beams. There two light bulbs required to have the high and low beams and any one of the two light bulbs burns, the corresponding light beam cannot be produced. The conventional head light generates glare when using the low beam and which makes the drivers of coming vehicles uncomfortable.

The present invention intends to provide a high beam and low beam switch mechanism which is used for head lights of Ploy-Ellipsoid System (PES) and only one light bulb is required and a cover plate is movably operated to block light beam that is not needed.

### SUMMARY OF THE INVENTION

The present invention relates to a head light assembly and includes a reflector with a parabolic inner surface and an open end. A light bulb is located in the reflector. A cover board has a recess defined in a top edge thereof and is connected to the open end of the reflector. A fixing plate is connected to an end of the cover board. A driving assembly includes an electromagnetic valve connected to a connection board which is fixed to the fixing plate. A cover plate has a connection portion at an end thereof and the push rod of the electromagnetic valve is connected to the connection portion so as to drive the cover plate to a first position to block the recess of the cover board and a second position to be located away from the recess of the cover board. A lens is engaged with the open end of the reflector 1.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show the switch mechanism of the head light assembly of the present invention;

FIG. 2 is an exploded view to show the switch mechanism of the head light assembly of the present invention;

FIG. 3 shows the cover plate is in a fist position to block the recess of the block board, and

FIG. 4 shows the cover plate is in a second position to be away from the recess of the block board.

### DETAILED DESCRIPTION OF THE PREFERRED EMBODIMENT

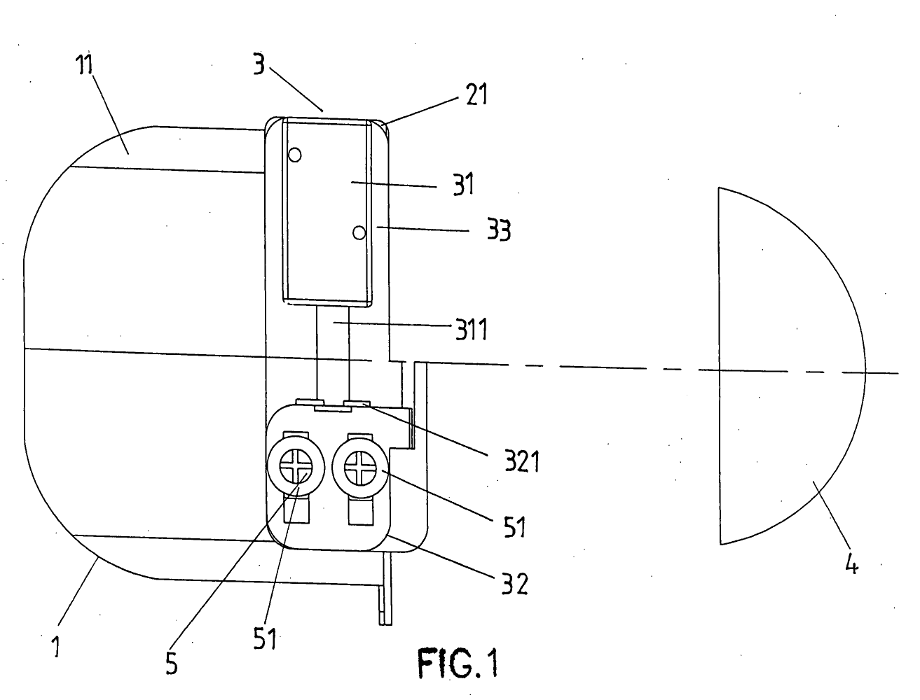

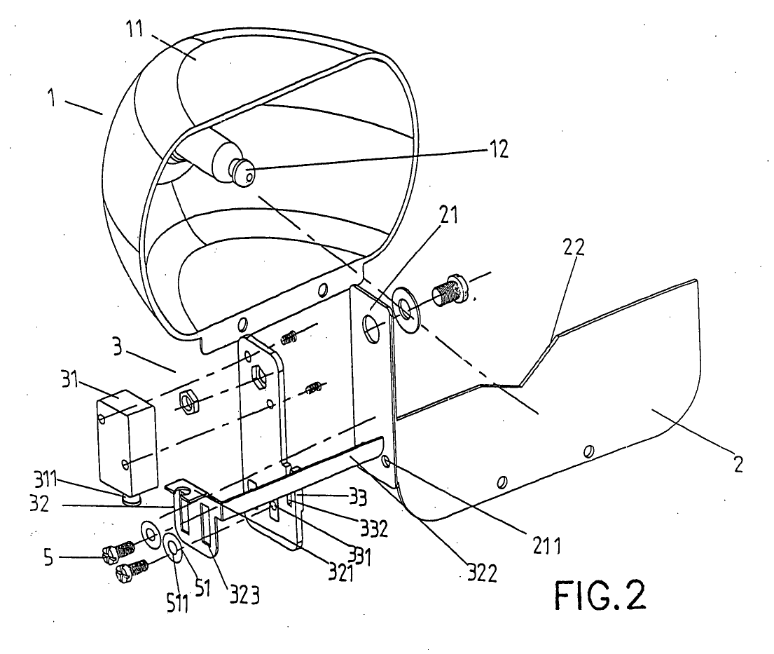

Referring to FIGS. 1 and 2, the head light assembly of the present invention comprises a reflector 1 with a parabolic inner surface 11 so as to define an open end and a light bulb 12 is located in the reflector 1. The light beam from the light bulb 12 will be reflected according to the curvature of the parabolic inner surface 11. A cover board 2 has a recess 22 defined in a top edge thereof and is connected to a lower periphery of the open end of the reflector 1, wherein the recess 22 is located lower than the light bulb 12. A fixing plate 21 is connected to an end of the cover board 2.

A driving assembly 3 includes an electromagnetic valve 31 connected to a connection board 33 which is fixed to the fixing plate 21. A push rod 311 retractably extends from the electromagnetic valve 31. A cover plate 322 has a connection portion 32 at an end thereof and an extension plate 321 extends from the connection portion 32. A notch is defined in the extension plate 321 so that the push rod 311 is securely engaged with the notch.

The connection board 33 includes two first elongate holes 331 and the connection portion 32 of the cover plate 322 includes two second elongate holes 323. Bolts 5 extend through two holes 511 in two washers 51, the first and second elongate holes 331, 323, and engaged with holes 211 in the fixing plate 21. Therefore, the connection portion 32 is allowed to be moved up and down along the first and second elongate holes 331, 323. The connection board 33 includes a slot 332 defined therein and the cover plate 322 is movably received in the slot 332. A lens 4 is engaged with the open end of the reflector 1.

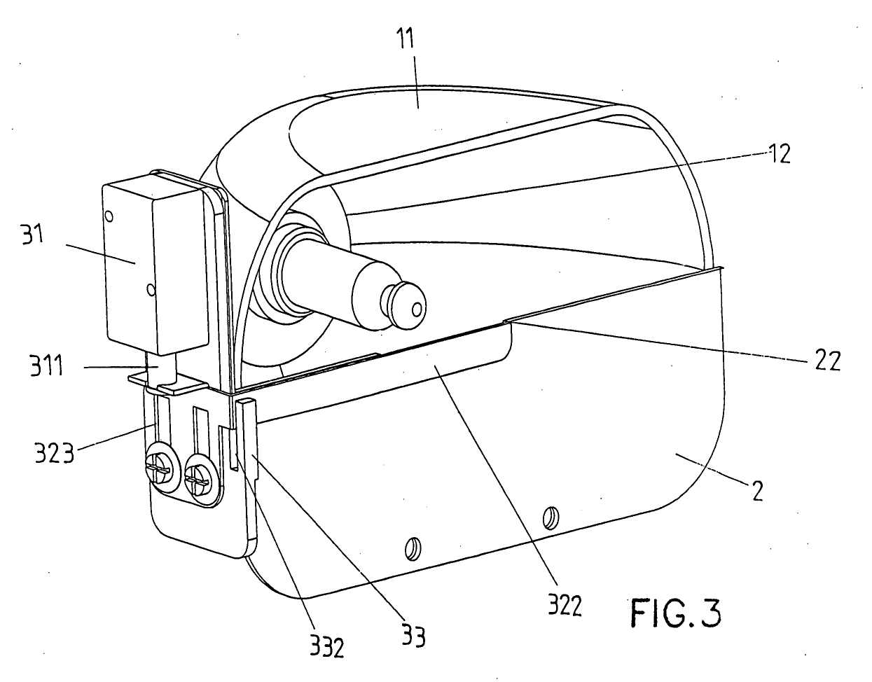

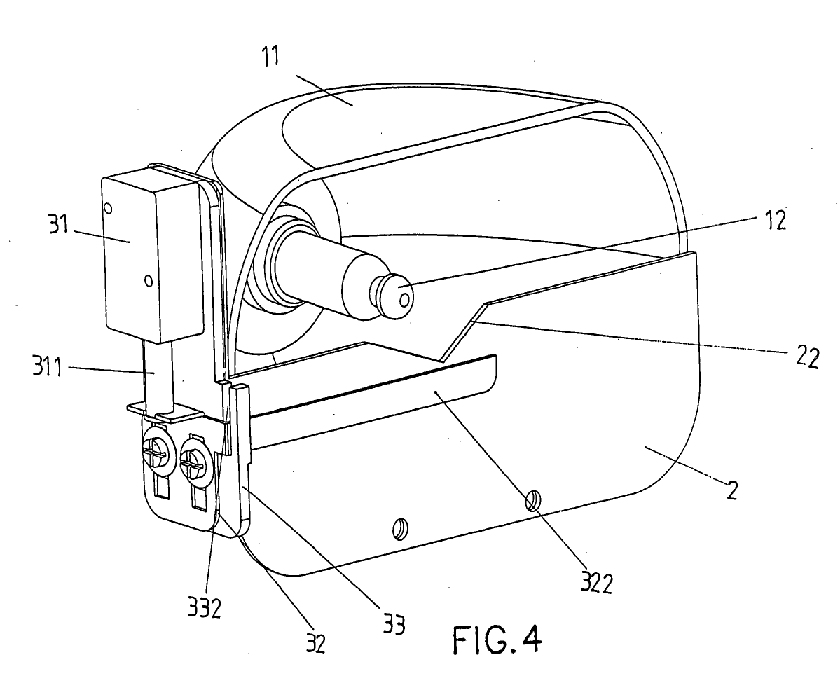

Further referring to FIG. 3, the push rod 311 is connected to the connection portion 32 so as to drive the cover plate 322 to a first position to block the recess 22 of the cover board 2 as shown in FIG. 3, and a second position to be located away from the recess 22 of the cover board 2 as shown in FIG. 4.

When the cover plate 322 is located in the first position as shown in FIG. 3, the light beam from the light bulb 12 reflected downward is blocked by the cover plate 322, and only the high beam is seen.

When he cover plate 322 is located in the second position as shown in FIG. 4, the light beam from the light bulb 12 reflected downward is not blocked by the cover plate 322 and goes through the recess 22 of the cover board 2.

While we have shown and described the embodiment in accordance with the present invention, it should be clear to those skilled in the art that further embodiments may be made without departing from the scope of the present invention.

What is claimed is:

1. A head light assembly comprising:
a reflector with a parabolic inner surface so as to define an open end, a light bulb located in the reflector;
a cover board having a recess defined in a top edge thereof and the cover board connected to the open end of the reflector, a fixing plate connected to an end of the cover board;
a driving assembly including an electromagnetic valve connected to a connection board which is fixed to the fixing plate, a push rod retractably extending from the electromagnetic valve, a cover plate having a connection portion at an end thereof and the push rod connected to the connection portion so as to drive the cover plate to a first position to block the recess of the cover board and a second position to be located away from the recess of the cover board, and
a lens engaged with the open end of the reflector.

2. The assembly as claimed in claim 1, wherein the connection board includes a slot defined therein and the cover plate movably received in the slot.

3. The assembly as claimed in claim 1, wherein the connection board includes two first elongate holes and the connection portion of the cover plate includes two second elongate holes, bolts extend through two washers, the first and second elongate holes to movably connect the connection portion of the cover plate to the connection board.

4. The assembly as claimed in claim 1, wherein the cover board is connected to a lower periphery of the open end of the reflector and the recess is located lower than the light bulb.

5. The assembly as claimed in claim 1, wherein the connection portion of the cover plate includes an extension plate and a notch is defined in the extension plate so that the push rod is securely engaged with the notch.
